(19) United States
(12) Patent Application Publication
(10) Pub. No.: US 2015/0337769 A1
(43) Pub. Date: Nov. 26, 2015

(54) FUEL SUPPLY SYSTEM AND PRESSURE REDUCING DEVICE

(71) Applicant: AISAN KOGYO KABUSHIKI KAISHA, Obu-shi (JP)

(72) Inventors: Mamoru YOSHIOKA, Nagoya-shi (JP); Keiso TAKEDA, Nagoya-shi (JP); Kazuhiro NAKAMURA, Ichinomiya-shi (JP); Masahiro KOBAYASHI, Toyohashi-shi (JP); Shigehito SUZUKI, Toyota-shi (JP); Akihisa HOTTA, Ichinomiya-shi (JP); Hideyuki FUKUDA, Nagoya-shi (JP)

(21) Appl. No.: 14/711,244

(22) Filed: May 13, 2015

(30) Foreign Application Priority Data
May 21, 2014 (JP) 2014-105140
Oct. 8, 2014 (JP) 2014-207227

(51) Int. Cl. F02M 21/02; F16K 17/04

(52) U.S. Cl. CPC F02M 21/0239; F16K 17/048

(57) ABSTRACT

A fuel supply system is configured to reduce the pressure of hydrogen gas delivered from a hydrogen cylinder by a high-pressure regulator arranged in series, regulate a flow rate of the pressure-reduced hydrogen gas by a hydrogen flow regulating device, and supply the hydrogen gas to a fuel cell. The high-pressure regulator includes a middle passage in which the hydrogen gas after being pressure-reduced by a first regulator and before being pressure-reduced by a second regulator enters, a rear passage in which the hydrogen gas after pressure-reduced by the second regulator enters, a communication passage allowing communication between the middle passage and the rear passage, and an internal air check valve provided in the communication passage and arranged to allow the hydrogen gas to flow in a direction from the middle passage toward the rear passage and block the hydrogen gas from flowing in a reverse direction thereto.

### CROSS-REFERENCE TO RELATED APPLICATIONS

This application is based upon and claims the benefit of priority from each of the prior Japanese Patent Applications No. 2014-105140 filed on May 21, 2014, and No. 2014-207227 filed on Oct. 8, 2014, the entire contents of which are incorporated herein by reference.

### BACKGROUND OF THE INVENTION

1. Field of the Invention

The present invention relates to a fuel supply system configured to supply fuel gas from a fuel storage container to a supply destination while reducing the pressure of the fuel gas, and a pressure reducing device used therein.

2. Related Art

As a technique of the above type, there has conventionally been known a fuel cell system disclosed in Japanese patent application publication No. 2007-323873 (JP-A-2007-323873), for example. This fuel cell system includes a fuel cell for generating electric power by electrochemical reaction between fuel gas (hydrogen gas) and oxidant gas (air), a hydrogen tank for storing hydrogen gas, and a hydrogen supply passage for supplying the hydrogen gas of the hydrogen tank to the fuel cell. In the hydrogen supply passage, two regulators arranged in series to regulate the pressure of the hydrogen gas in two stages and an injector for regulating a flow rate of the hydrogen gas to be supplied to the fuel cell. It is configured to reduce the pressure of the hydrogen gas in the hydrogen tank in a stepwise fashion, and inject the pressure-reduced fuel gas through the injector to supply the fuel gas to the fuel cell.

The regulator is a device for regulating an upstream-side pressure (primary pressure) thereof to a secondary pressure set in advance and is constituted of a mechanical pressure reducing valve configured to reduce the primary pressure. Since the two regulators are arranged in series on an upstream side of the injector, the upstream-side pressure of the injector can be effectively reduced. Accordingly, the design freedom of the mechanical structure of the injector can be increased.

### SUMMARY OF INVENTION

### Problem to be Solved by the Invention

In the fuel cell system disclosed in JP-A-2007-323873, however, the downstream-side pressure of the second-stage regulator of the two regulators does not decrease during non-operation of the system. Therefore, the hydrogen gas having leaked from the first-stage regulator is not allowed to escape, and the pressure of this hydrogen gas acts on a passage between the downstream side of the first-stage regulator and the upstream side of the second-stage regulator, further acts on seal members of the regulators. This may cause sealing failure or breakage of the seal members.

The present invention has been made in view of the above circumstances and has a purpose to provide a fuel supply system arranged to reduce the pressure of the fuel gas delivered from a fuel storage container by a plurality of pressure reducing valves arranged in series, regulate a flow rate of the pressure-reduced fuel gas and supply this fuel gas to a supply destination, the system being configured to prevent sealing failure and breakage due to the pressure of the fuel gas having leaked into a middle passage located between a downstream side of a first pressure reducing valve and an upstream side of a second pressure reducing valve.

### Means of Solving the Problem

To achieve the above purpose, one aspect of the invention provides a fuel supply system including: a fuel storage container for storing fuel gas; a fuel supply passage for supplying the fuel gas from the fuel storage container to a supply destination; a plurality of pressure reducing valves provided in the fuel supply passage downstream of the fuel storage container and arranged in series to reduce pressure of the fuel gas; and a fuel flow regulating device provided in the fuel supply passage downstream of the plurality of pressure reducing valves and configured to regulate a flow rate of fuel gas to be supplied to the supply destination, wherein the plurality of pressure reducing valves include a first pressure reducing valve placed on an uppermost side and a second pressure reducing valve placed next to the first pressure reducing valve, and the fuel supply system includes: a middle passage in which fuel gas after being pressure-reduced by the first pressure reducing valve and before being pressure-reduced by the second pressure reducing valve; a rear passage in which the fuel gas after being pressure-reduced by the second pressure reducing valve; and a gas releasing device configured to release the fuel gas from the middle passage only when pressure of the fuel gas in the middle passage becomes excessive.

### Effects of the Invention

According to the present invention, it is possible to prevent sealing failure and breakage due to the pressure of the fuel gas having leaked into a middle passage located between a downstream side of a first pressure reducing valve and an upstream side of a second pressure reducing valve.

### BRIEF DESCRIPTION OF THE DRAWING

FIG. 1 is a schematic structural diagram of a fuel cell system in a first embodiment;

FIG. 2 is a schematic sectional view of a high-pressure regulator in the first embodiment;

FIG. 3 is a sectional view of a high-pressure regulator in a second embodiment;

FIG. 4 is a sectional view of a high-pressure regulator in a third embodiment;

FIG. 5 is a schematic structural diagram of a fuel cell system in a fourth embodiment;

FIG. 6 is a sectional view of the high-pressure regulator in the fourth embodiment;

FIG. 7 is a sectional view of an atmosphere check valve in the fourth embodiment;

FIG. 8 is a sectional view of the atmosphere check valve in the fourth embodiment;

FIG. 9 is a sectional view of a high-pressure regulator in a fifth embodiment;

FIG. 10 is a plan view of the high-pressure regulator in the fifth embodiment;

FIG. 11 is a schematic structural diagram of a fuel cell system in a sixth embodiment;

FIG. 12 is a sectional view of the high-pressure regulator in the sixth embodiment;

FIG. 13 is sectional view of a high-pressure regulator in a seventh embodiment;

FIG. 14 is a sectional view of a two-stage check valve in the seventh embodiment;

FIG. 15 is a sectional view of the two-stage check valve in the seventh embodiment;

FIG. 16 is a sectional view of the two-stage check valve in the seventh embodiment; and

FIG. 17 is a schematic structural diagram of a bifuel engine system in an eighth embodiment.

### DESCRIPTION OF EMBODIMENTS

### First Embodiment

A detailed description of a first embodiment of a fuel supply system and a pressure reducing device of the present invention embodied in a fuel cell system will now be given referring to the accompanying drawings.

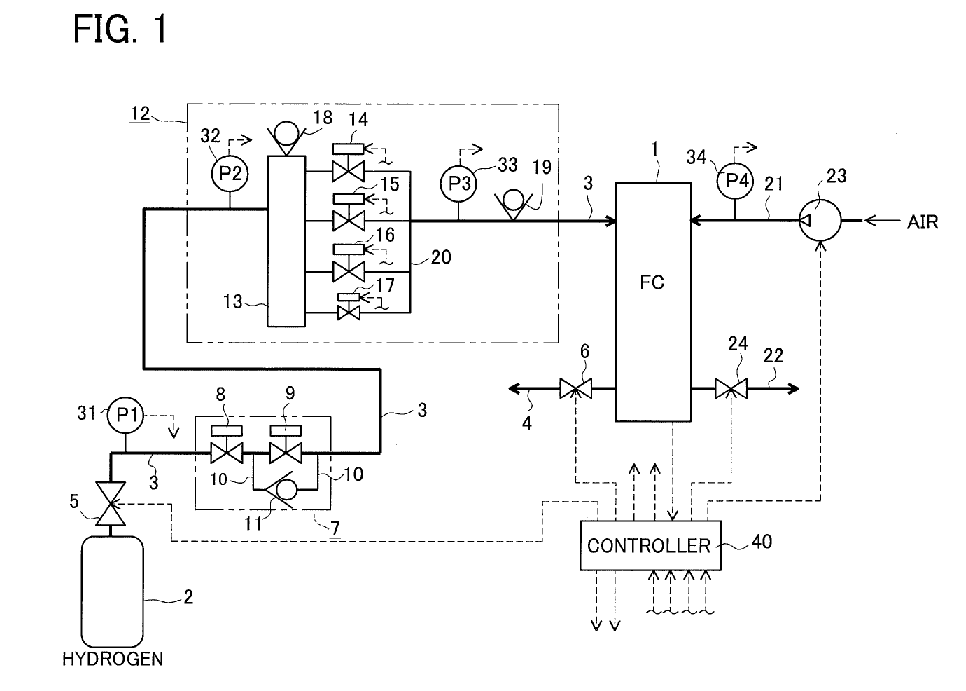

FIG. 1 is a schematic structural diagram of a fuel cell system in this embodiment. This fuel cell system will be mounted in an electric vehicle and used to supply electric power to a drive motor thereof (not shown). The fuel cell system includes a fuel cell (FC) 1 and a hydrogen cylinder 2. The fuel cell 1 is configured to generate electric power from hydrogen gas as fuel gas and air as oxidant gas supplied thereto. The electric power generated in the fuel cell 1 will be supplied to the drive motor through an inverter (not shown). The hydrogen cylinder 2 corresponds to one example of a fuel storage container of the invention and is used to store high-pressure hydrogen gas.

On an anode side of the fuel cell 1, a hydrogen supply system is provided as a fuel supply system of the invention. This hydrogen supply system includes a hydrogen supply passage 3 for supplying hydrogen gas from the hydrogen cylinder 2 to the fuel cell 1 which is a supply destination, and a hydrogen discharge passage 4 for discharging out hydrogen offgas delivered out of the fuel cell 1. The hydrogen supply passage 3 corresponds to one example of a fuel supply passage of the invention. In the hydrogen supply passage 3 immediately downstream of the hydrogen cylinder 2, there is provided a main stop valve 5 constituted of an electromagnetic valve for switching between supply and shutoff of hydrogen gas from the hydrogen cylinder 2 to the hydrogen supply passage 3. In the hydrogen discharge passage 4, a first changeover valve 6 constituted of an electromagnetic valve is provided.

In the hydrogen supply passage 3 downstream of the main stop valve 5, there is provided a high-pressure regulator 7 to reduce the pressure of the hydrogen gas. The high-pressure regulator 7 corresponds to one example of a pressure reducing device of the present invention. In the hydrogen supply passage 3 located between the main stop valve 5 and the high-pressure regulator 7, a primary pressure sensor 31 is provided to detect the pressure in this passage 3 as a primary pressure P1. This primary pressure P1 may be assigned a value in a range of 0.1 to 90 (MPa), for example.

The high-pressure regulator 7 includes a first regulator 8 and a second regulator 9 arranged in series, a communication passage 10 allowing communication between an upstream side and a downstream side of the second regulator 9, and an internal air check valve 11 provided in the communication passage 10, which are integrally configured as a single unit. The first regulator 8 corresponds to one example of a first pressure reducing valve of the present invention. The second regulator 9 corresponds to one example of a second pressure reducing valve of the invention. In the high-pressure regulator 7, the pressure of the hydrogen gas reduced by the first regulator 8 is further reduced by the second regulator 9, that is, the pressure of the hydrogen gas is reduced in two stages.

In the hydrogen supply passage 3 downstream of the high-pressure regulator 7, there is provided a hydrogen flow regulating device 12 for regulating a flow rate of hydrogen gas to be supplied to the fuel cell 1. This hydrogen flow regulating device 12 corresponds to one example of a fuel flow regulating device of the invention and includes a delivery pipe 13 and a plurality of injectors 14, 15, 16, and 17. The delivery pipe 13 is arranged to distribute the hydrogen gas of the hydrogen supply passage 3 to the plurality of injectors 14 to 17 and thus has a predetermined volume. With respect to this delivery pipe 13, the injectors 14 to 17 are connected in parallel. The delivery pipe 13 is provided with an intermediate-pressure relief valve 18 which will be opened when the pressure in the delivery pipe 13 exceeds a predetermined value (e.g., 3 (MPa)) to release the pressure. The injectors 14 to 17 includes the first injector 14, the second injector 15, and the third injector 16 each of which will inject the hydrogen gas with a normal flow rate and the fourth injector 17 which will inject the hydrogen gas with a smaller flow rate than the normal flow rate. Each of the injectors 14 to 17 is set with a valve opening pressure, corresponding to the pressure of hydrogen gas acting on respective upstream side, to enable valve opening of each of the injectors 14 to 17. In this embodiment, the valve opening pressures of the injectors 14 to 17 are individually set for example so that the valve opening pressure of the first to third injectors 14 to 16 is 3 (MPa) and the valve opening pressure of the fourth injector 17 is 10 (MPa). In the hydrogen supply passage 3 immediately upstream of the delivery pipe 13, a secondary pressure sensor 32 is provided to detect the pressure in the passage 3 as a secondary pressure P2. The secondary pressure P2 may be applied with a value in a range of 1.1 to 1.6 (MPa) for example.

A downstream side of each injector 14 to 17 is connected to the fuel cell 1 through the hydrogen supply passage 3. In the hydrogen supply passage 3 at a position immediately downstream of each injector 14 to 17, a tertiary pressure sensor 33 is provided to detect the internal pressure of the passage 3 at that position as a tertiary pressure P3. This tertiary pressure P3 may be applied with a value in a range of 0.1 to 0.3 (MPa) for example. In the hydrogen supply passage 3 downstream of the tertiary pressure sensor 33, there is provided a low-pressure relief valve 19 configured to open when the pressure of the passage 3 becomes a predetermined value or more to release that pressure.

In the present embodiment, the delivery pipe 13, each injector 14 to 17, the intermediate-pressure relief valve 18, the low-pressure relief valve 19, the secondary pressure sensor 32, the tertiary pressure sensor 33, and a pipe 20 connecting these components are integrally configured as a single unit.

On the other hand, on a cathode side of the fuel cell 1, there are provided an air supply passage 21 for supplying air to the fuel cell 1, and an air discharge passage 22 for discharging out air offgas to be delivered out of the fuel cell 1. In the air supply passage 21, an air pump 23 is provided to regulate a flow rate of air to be supplied to the fuel cell 1. In the air supply passage 21 downstream of the air pump 23, an air pressure sensor 34 is provided to detect air pressure P4. In the air discharge passage 22, a second changeover valve 24 constituted of an electromagnetic valve is provided.

In the above structure, the hydrogen gas delivered out of the hydrogen cylinder 2 will be supplied to the fuel cell 1 by passing through the hydrogen supply passage 3 via the main stop valve 5, the high-pressure regulator 7, and the hydrogen flow regulating device 12. The hydrogen gas supplied to the fuel cell 1 is used for power generation in this cell 1 and then discharged as hydrogen offgas from the cell 1 through the hydrogen discharge passage 4 and the first changeover valve 6.

In the above configuration, the air discharged from the air pump 23 to the air supply passage 21 will be supplied to the fuel cell 1. The air supplied to the fuel cell 1 is used for power generation in the cell 1 and then discharged as air offgas from the cell 1 through the air discharge passage 22 and the second changeover valve 24.

The above fuel cell system further includes a controller 40 operative to control the system. The controller 40 is configured to control the main stop valve 5 and each of the injectors 14 to 17 based on detection values of the primary pressure sensor 31, the secondary pressure sensor 32, and the tertiary pressure sensor 33 in order to control a flow of the hydrogen gas to be supplied to the fuel cell 1. Further, the controller 40 is also configured to control the first changeover valve 6 in order to control a flow of hydrogen offgas of the hydrogen discharge passage 4. On the other hand, the controller 40 is arranged to control the air pump 23 based on a detection value of the air pressure sensor 34 in order to control a flow of air to be supplied to the fuel cell 1. Further, the controller 40 is configured to control the second changeover valve 24 in order to control a flow of air offgas in the air discharge passage 22. The controller 40 is further configured to receive each of a voltage value and a current value related to power generation in the fuel cell 1. The controller includes a central processing unit (CPU) and a memory and is configured to control each of the injectors 14 to 17, the air pump 23, and others based on a predetermined control program stored in the memory in order to control a hydrogen gas amount and an air amount to be supplied to the fuel cell 1.

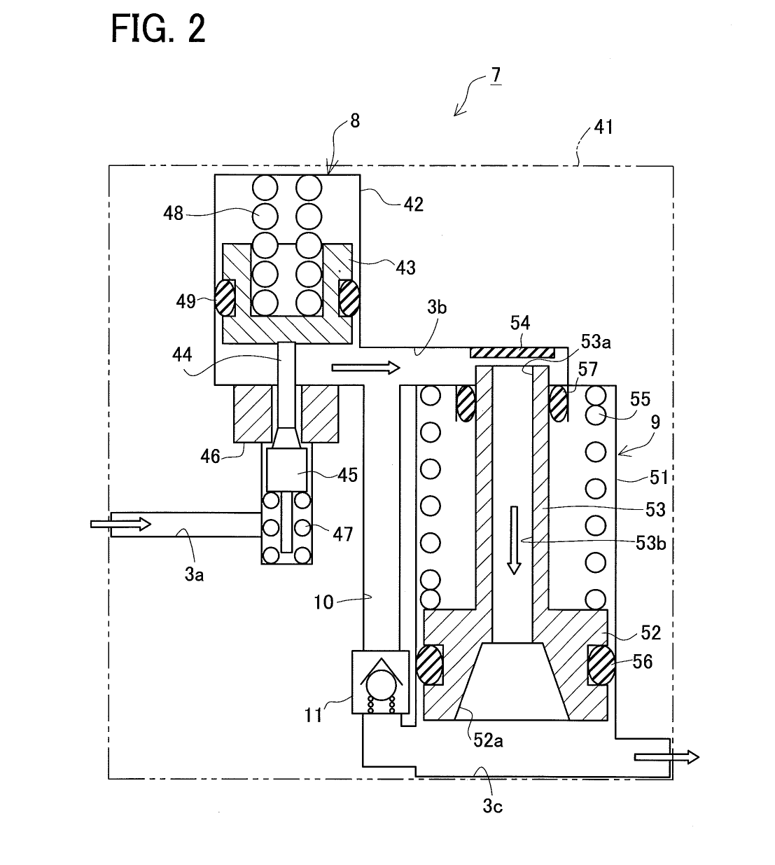

Herein, the details of the high-pressure regulator 7 will be explained. FIG. 2 is a schematic sectional view of the high-pressure regulator 7. This high-pressure regulator 7 is provided with a casing 41 and, in this casing 41, integrally includes the first regulator 8, the second regulator 9, a front passage 3a, a middle passage 3b, a rear passage 3c, the communication passage 10, and the internal air check valve 11. The front passage 3a is the space in which hydrogen gas before being pressure-reduced by the first regulator 8 enters. The middle passage 3b is the space in which the hydrogen gas after being pressure-reduced by the first regulator 8 and before being pressure-reduced by the second regulator 9 enters. The rear passage 3c is the space in which hydrogen gas after being pressure-reduced by the second regulator 9 enters. In the casing 41, the first regulator 8 is placed on an upstream side and the second regulator 9 is placed on a downstream side, and the communication passage 10 and the internal air check valve 11 are arranged between the first regulator 8 and the second regulator 9. The internal air check valve 11 is configured to allow the hydrogen gas to flow in a direction from the middle passage 3b toward the rear passage 3c through the communication passage 10, but block the hydrogen gas from flowing in a reverse direction from the rear passage 3c toward the middle passage 3b. In this embodiment, specifically, the internal air check valve 11 is operated to allow the hydrogen gas to flow when the pressure of the hydrogen gas flowing from the middle passage 3b to the rear passage 3c is larger than a certain pressure (the valve opening pressure). In the present embodiment, the valve opening pressure of the internal air check valve 11 is set to be larger than the pressure obtained by adding a predetermined value a to the normal regulation pressure of the hydrogen gas in the middle passage 3b. In the present embodiment, the communication passage 10 and the internal air check valve 11 constitute a gas releasing device of the present invention to release the hydrogen gas from the middle passage 3b only when the pressure of hydrogen gas in the middle passage 3b becomes excessive.

The first regulator 8 includes a first cylinder 42, a first piston 43 placed in the first cylinder 42, a rod 44 extending downward from the first piston 43, a valve element 45 provided at a lower end of the rod 44, a valve seat 46 provided in the front passage 3a corresponding to the valve element 45, a valve-closing spring 47 urging the valve element 45 together with the rod 44 and the first piston 43 in a direction to close the valve element 45, and a valve-opening spring 48 urging the first piston 43 together with the rod 44 and the valve element 45 in a direction to open the valve element 45. A seal member 49 is provided on an outer periphery of the first piston 43 to seal between the first piston 43 and the first cylinder 42. Thus, the first regulator 8 is activated by the balance between the pressure of the hydrogen gas acting on the front passage 3a upstream of the regulator 8, the pressure of the hydrogen gas in the middle passage 3b, the urging force of the valve-closing spring 47, and the urging force of the valve-opening spring 48, to reduce the pressure of the hydrogen gas acting on the upstream side of the first regulator 8.

The second regulator 9 includes a second cylinder 51, a second piston 52 placed in the second cylinder 51, a tube 53 provided integral with and extending upward from the second piston 52, a valve seat 54 provided in the middle passage 3b corresponding to an upper end of the tube 53, and a valve-opening spring 55 urging the second piston 52 together with the tube 53 in a direction to separate an opening 53a of the upper end of the tube 53 from the valve seat 54. The second piston 52 is formed to be hollow, and a hollow part 52a thereof communicates with a hollow part 53b of the tube 53. A seal member 56 is provided on an outer periphery of the second piston 52 to seal between the second piston 52 and the second cylinder 51. A seal member 57 is also provided between an outer periphery of an upper end portion of the tube 53 and the middle passage 3b. Accordingly, the second regulator 9 is activated by the balance between the pressure of hydrogen gas after pressure-reduced in the middle passage 3b upstream of the regulator 9, the pressure of hydrogen gas in the rear passage 3, and the urging force of the valve-opening spring 55, to further reduce the pressure of hydrogen gas acting on the upstream side of the second regulator 9.

According to the hydrogen supply system and the high-pressure regulator 7 in the present embodiment, for example, during non-operation of the fuel cell system, the hydrogen gas may leaks from the first regulator 8 into the middle passage 3b located between the first regulator 8 and the second regulator 9, and thus the pressure of the hydrogen gas in the middle passage 3b may increase. To avoid this, the internal air check valve 11 provided in the communication passage 10 is opened to allow a flow of the hydrogen gas from the middle passage 3b toward the rear passage 3c through the communication passage 10, that is, release the hydrogen gas from the middle passage 3b, thereby reducing the pressure of the hydrogen gas in the middle passage 3b. Accordingly, the pressure of the hydrogen gas having leaked into the middle passage 3b is prevented from becoming excessive, thus preventing sealing failure and breakage of the seal members 49 and 57 facing the middle passage 3b. Further, since the hydrogen gas can be relieved to the rear passage 3c without relieving to the outside of the hydrogen supply system, the hydrogen gas can be relieved without wasteful consumption of fuel (hydrogen).

In the unitized high-pressure regulator 7, herein, even when the first regulator 8 remaining open is broken, causing excessive pressure of hydrogen gas to act on the middle passage 3b, the internal air check valve 11 is opened to release the pressure of the middle passage 3b to the rear passage 3c through the communication passage 10. Therefore, the internal air check valve 11 can function as a relief valve for the high-pressure regulator 7.

In the present embodiment, moreover, the communication passage 10 and the internal air check valve 11 are placed in a marginal space between the first regulator 8 and the second regulator 9, so that any special space for the high-pressure regulator 7 as a unit needs not be provided. This can prevent an increase in size of the high-pressure regulator 7 including the first regulator 8 and the second regulator 9 more than needed due to the addition of the communication passage 10 and the internal air check valve 11.

### Second Embodiment

A second embodiment of a fuel supply system and a pressure reducing device of the invention embodied in a fuel cell system will be explained in detail, referring to the accompanying drawing.

In the following explanation, identical or similar components to those in the first embodiment are assigned the same reference signs and their details are not explained herein. Thus, the following explanation will be given to differences from the first embodiment.

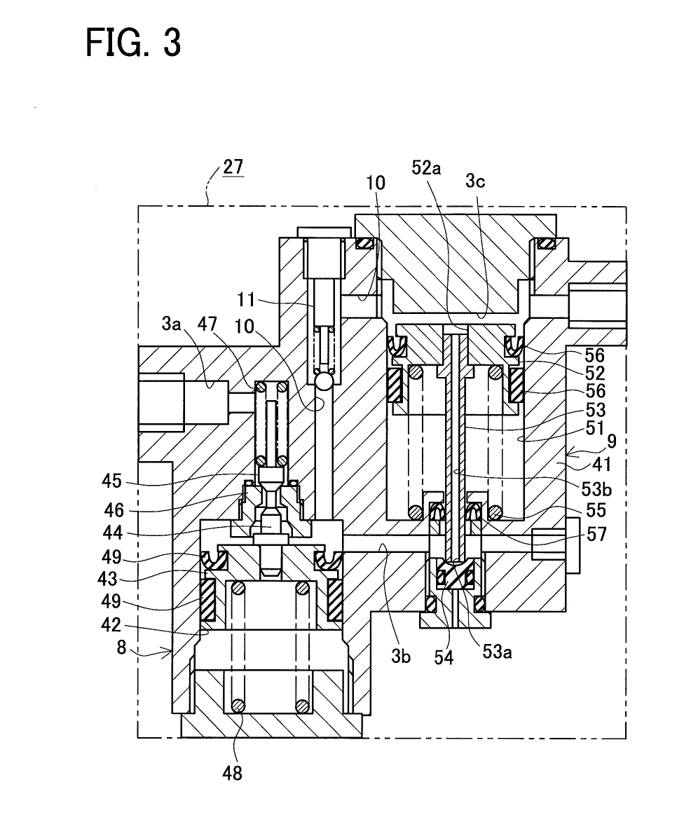

FIG. 3 is a sectional view of a high-pressure regulator 27 in this embodiment. As compared with the high-pressure regulator 7 shown in FIG. 2, the high-pressure regulator 27 is configured such that the first regulator 8 is placed in an inverted orientation and the second regulator 9 is placed in an inverted orientation. Thus, in the high-pressure regulator 27, differently in structure from the first embodiment, the front passage 3a and the rear passage 3c are located in positions above the middle passage 3b.

Accordingly, the hydrogen supply system and the high-pressure regulator 27 in the present embodiment can also provide the equivalent operation advantage to that in the first embodiment.

### Third Embodiment

A third embodiment of a fuel supply system and a pressure reducing device of the present invention embodied in a fuel cell system will be explained in detail, referring to the accompanying drawing.

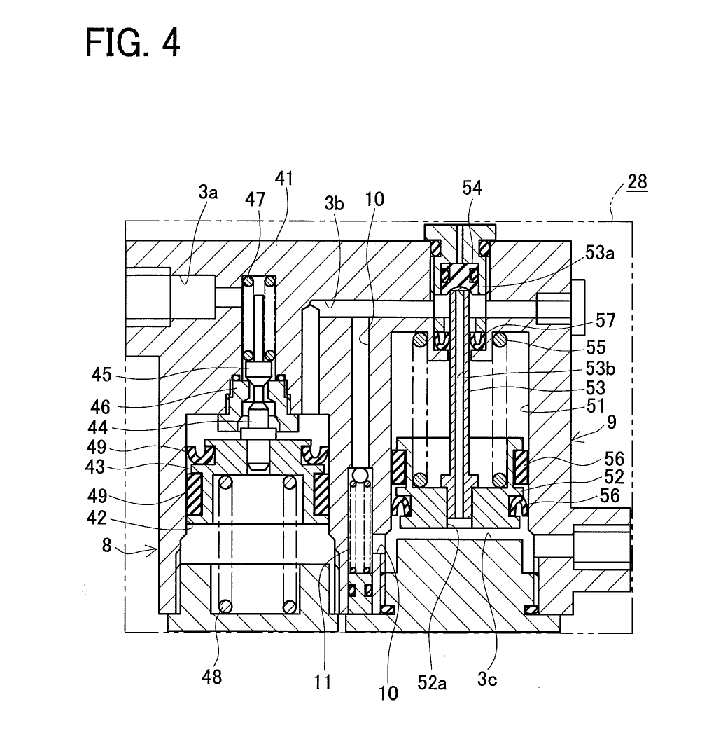

FIG. 4 is a sectional view of a high-pressure regulator 28 in the third embodiment. As compared with the high-pressure regulator 7 shown in FIG. 2, the high-pressure regulator 28 in this embodiment is configured such that the first regulator 8 is placed in an inverted orientation and the first regulator 8 and the second regulator 9 are placed with their lower ends aligned at the same level. Thus, in the high-pressure regulator 28, differently in structure from the first embodiment, the front passage 3a and the middle passage 3b are located in positions above the rear passage 3c.

Accordingly, the hydrogen supply system and the high-pressure regulator 28 in the present embodiment can also provide the equivalent operation advantage to that in the first embodiment. In addition, the first regulator 8, the communication passage 10, and the internal air check valve 11 are set in a range corresponding to the height of the regulator 9. Thus, the size in a height direction of the high-pressure regulator 28 can be reduced as compared with the high-pressure regulator 27 in the second embodiment.

### Fourth Embodiment

A fourth embodiment of a fuel supply system and a pressure reducing device of the present invention embodied in a fuel cell system will be explained in detail, referring to the accompanying drawings.

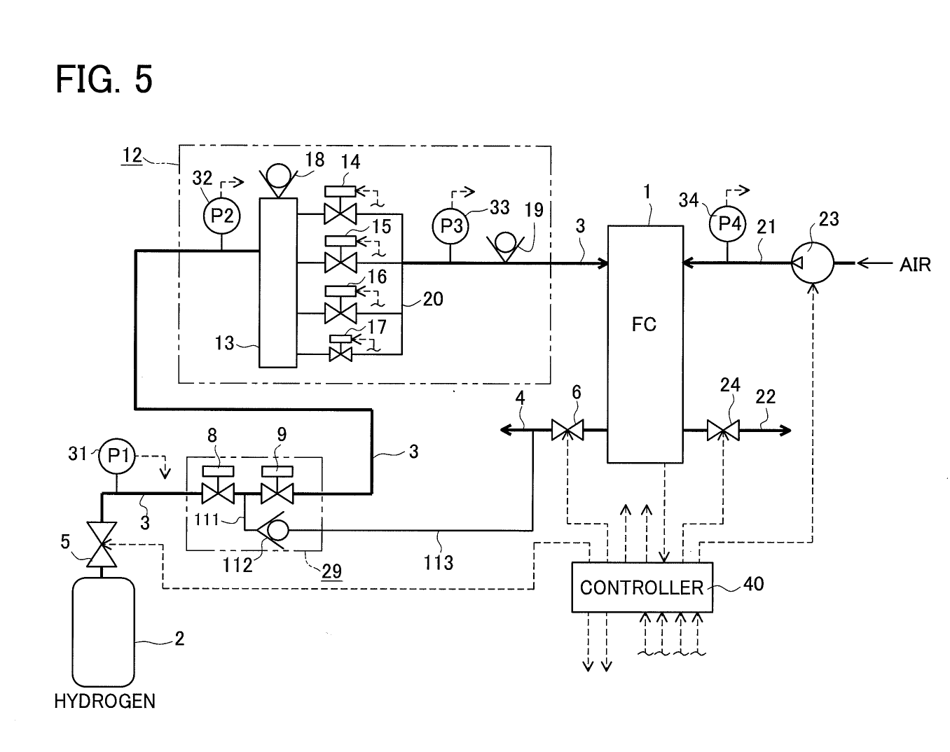

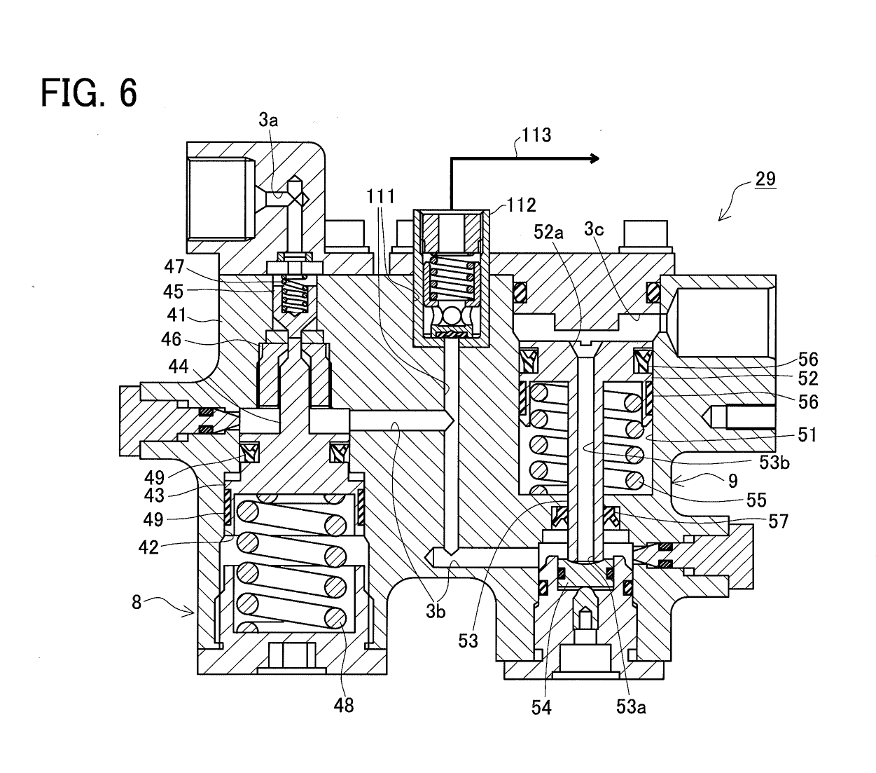

FIG. 5 is a schematic structural diagram of a fuel cell system in the fourth embodiment. FIG. 6 is a sectional view of a high-pressure regulator 29. As shown in FIG. 6, the structure of this high-pressure regulator 29 and the placement of the first and second high-pressure regulators 8 and 9 are basically the same as those of the high-pressure regulator 27 shown in FIG. 3. Thus, the front passage 3a and the rear passage 3c in the high-pressure regulator 29 are also placed in positions above the middle passage 3b. The present embodiment differs from each of the above embodiments in the structure that, as shown in FIGS. 5 and 6, the high-pressure regulator 29 is provided with an atmosphere communication passage 111 allowing communication between the middle passage 3b and atmosphere, instead of the communication passage 10 allowing communication between the middle passage 3b and the rear passage 3c, and an atmosphere check valve 112 is provided in this atmosphere communication passage 111. As shown in FIG. 6, the atmosphere check valve 112 is placed in the casing 41 in such a way as to be press-fitted in a part of the atmosphere communication passage 111. An upper end portion of the atmosphere check valve 112 protrudes upward from the casing 41. This upper end portion of the atmosphere check valve 112 is connected with a pipe 113 constituting the atmosphere communication passage. As shown in FIG. 5, a leading end of this pipe 113 is connected to the hydrogen discharge passage 4 and hence is communicated with atmosphere. The atmosphere check valve 112 provided in the atmosphere communication passage 111 is configured to allow a flow of the hydrogen gas in a direction from the middle passage 3b toward the atmosphere communication passage 111 and block a flow of the hydrogen gas in a reverse direction from the atmosphere communication passage 111 toward the middle passage 3b. In the present embodiment, the atmosphere communication passage 111, the pipe 113, and the atmosphere check valve 112 constitute a gas releasing device of the present invention.

Also in the present embodiment, as shown in FIG. 6, the first regulator 8, the second regulator 9, the front passage 3a, the middle passage 3b, the rear passage 3c, the atmosphere communication passage 111, and the atmosphere check valve 112 are integrally provided as a single unit to constitute the high-pressure regulator 29. In this high-pressure regulator 29, the first regulator 8 is placed on an upstream side and the second regulator 9 is placed on a downstream side, and the atmosphere communication passage 111 and the atmosphere check valve 112 are placed between the first regulator 8 and the second regulator 9.

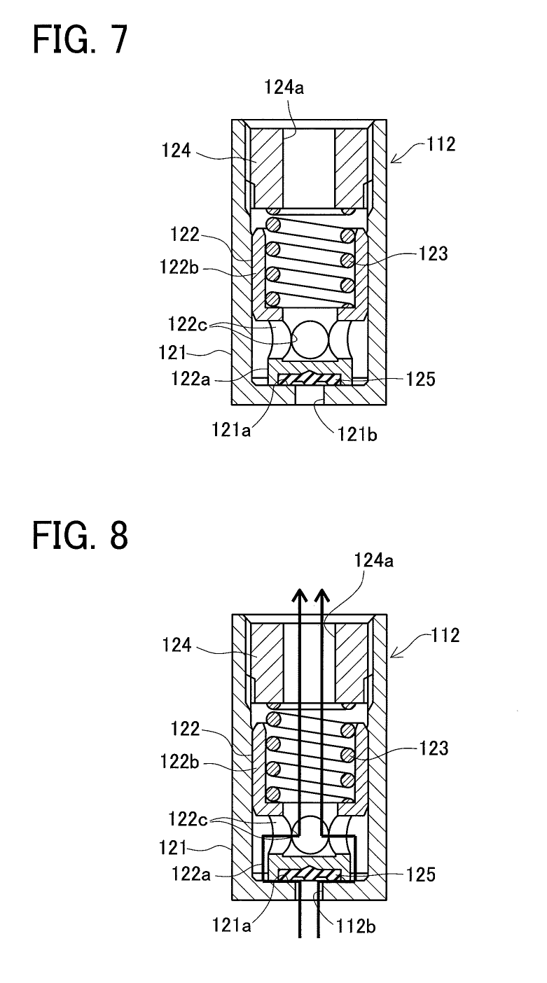

FIGS. 7 and 8 are sectional views of the atmosphere check valve 112. This atmosphere check valve 112 includes a hollow cylindrical casing 121, a valve seat 121a formed in the casing 121, a nearly cylindrical valve element 122 provided in the casing 121 to be seatable on the valve seat 121a, a spring 123 urging the valve element 122 in a direction to seat on the valve seat 121a (a valve-closing direction), and a ring-shaped stopper 124 holding the spring 123. The valve seat 121a is formed, at its center, with a valve hole 121b serving as an entrance. The valve element 122 includes a small-diameter portion 122a on a leading end side and a large-diameter portion 122b on a base end side, and the small-diameter portion 122a is formed with a plurality of communication holes 122c. A rubber sheet 125 is fixed to the leading end of the small-diameter portion 122a. A contact surface of the rubber sheet 125 which will contact with the valve seat 121a is formed with a protruding lip. This lip of the rubber sheet 125 seals between the valve element 122 and the valve seat 121a. Thus, when excessive pressure of the hydrogen gas in the middle passage 3b acts on the valve hole 121b of the valve seat 121a, the rubber sheet 125 of the valve element 122 slightly moves away (valve-opening) from the valve seat 121a against the urging force of the spring 123. At that time, as indicated by arrows in FIG. 8, the hydrogen gas flows from the middle passage 3b to atmosphere. Specifically, the hydrogen gas enters in the valve hole 121b, passes between the valve seat 121a and the rubber sheet 125, then passes through the inside of the valve element 122 through the communication holes 122c, and flows out of the casing 121 through the holes 124a of the stopper 124.

According to the hydrogen supply system and the high-pressure regulator 29 in the present embodiment explained above, for instance, during non-operation of the fuel cell system, the hydrogen gas may leak from the first regulator 8 into the middle passage 3b, and thus the pressure of the hydrogen gas in the middle passage 3b may increase. To avoid this, the atmosphere check valve 112 provided in the atmosphere communication passage 111 is opened to allow the hydrogen gas to flow from the middle passage 3b to atmosphere through the atmosphere communication passage 111 and the pipe 113, that is, release the hydrogen gas from the middle passage 3b, thereby reducing the pressure of the hydrogen gas in the middle passage 3b. Accordingly, the pressure of the hydrogen gas having leaked into the middle passage 3b is prevented from becoming excessive, thus preventing sealing failure and breakage of the seal members 49 and 57 facing the middle passage 3b. Further, the high-pressure hydrogen gas can be relieved to atmosphere, or outside the hydrogen supply system, without relieving to the inside of the rear passage 3c downstream of the second regulator 9. This can relieve a large amount of hydrogen gas at once as compared with the case of relieving into the rear passage 3c, prevent the pressure of the hydrogen gas in the rear passage 3c from increasing more than necessary, and ensure pressure resistance of the high-pressure regulator 29.

Herein, in the unitized high-pressure regulator 29, even when the first regulator 8 remaining open is broken, causing excessive pressure of hydrogen gas to act on the middle passage 3b, the atmosphere check valve 112 is opened to release the pressure of the middle passage 3b to atmosphere through the atmosphere communication passage 111, the pipe 113, and the hydrogen discharge passage 4. Therefore, the atmosphere check valve 112 and the high-pressure regulator 29 can be function as a relief valve for the high-pressure regulator 29.

In FIG. 5, when the main stop valve 5 is opened from a valve-closed state, the high pressure of hydrogen gas is applied at once to the high-pressure regulator 29. At that time, when the first regulator 8 is late in closing, the pressure of the hydrogen gas in the middle passage 3b between the first regulator 8 and the second regulator 9 rises. At that time, the atmosphere check valve 112 is opened to allow the pressure in the middle passage 3b to release to atmosphere, thereby preventing excessive pressure rise (overshoot) in the middle passage 3b. This can reduce a demand for pressure resistance of the high-pressure regulator 29.

Also in the present embodiment, the atmosphere communication passage 111 and the atmosphere check valve 112 are placed in the marginal space between the first regulator 8 and the second regulator 9, so that any special space for the high-pressure regulator 29 as a unit needs not be provided. This can prevent an increase in size of the high-pressure regulator 29 including the first regulator 8 and the second regulator 9 more than needed due to the addition of the atmosphere communication passage 111 and the atmosphere check valve 112.

### Fifth Embodiment

A fifth embodiment of a fuel supply system and a pressure reducing device of the present invention embodied in a fuel cell system will be explained in detail, referring to the accompanying drawings.

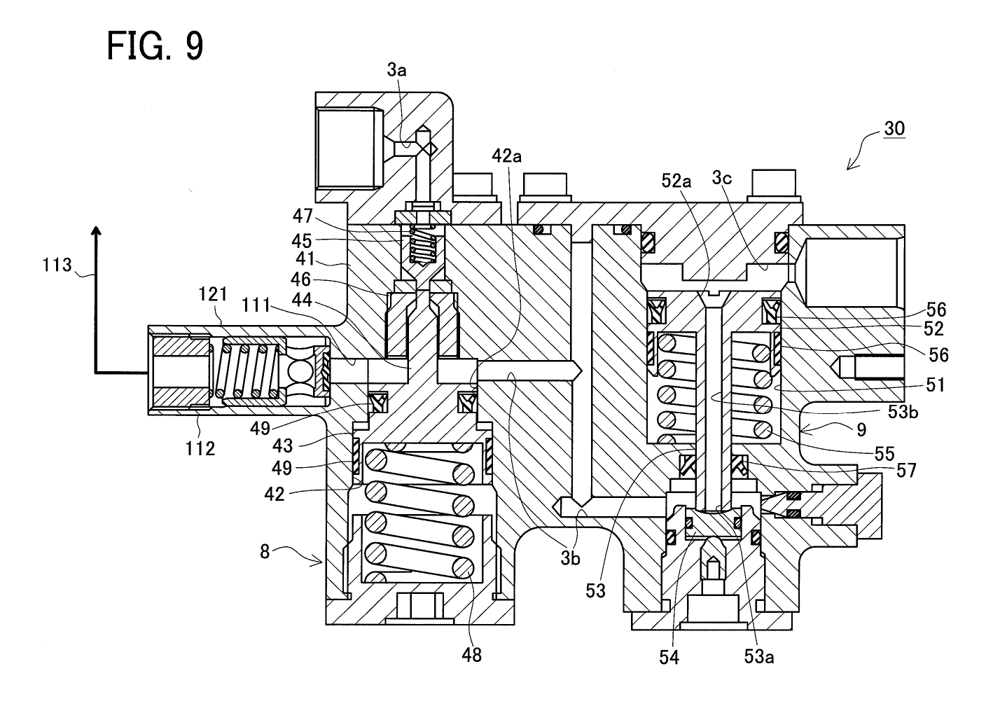

The fifth embodiment differs from the fourth embodiment in structure in terms of the placement of the atmosphere communication passage 111 and the atmosphere check valve 112. FIG. 9 is a sectional view of a high-pressure regulator 30 in this embodiment. The fifth embodiment differs from the fourth embodiment in that the first regulator 8 includes a first cylinder 42 and a first piston 43, an opening 42a of the first cylinder 42 is communicated with the middle passage 3b, and the atmosphere communication passage 111 and the atmosphere check valve 112 are placed adjacent to the opening 42a. In this embodiment, the atmosphere communication passage 111 and the atmosphere check valve 112 are placed in the casing 41 in a range not corresponding to a downstream side of the first cylinder 42. Specifically, as shown in FIG. 9, the atmosphere communication passage 111 is placed to extend in an opposite direction to an extending direction of the middle passage 3b with respect to the first cylinder 42 as a center. The atmosphere check valve 112 is placed to protrude in a horizontal direction from an open end of the atmosphere communication passage 111. The atmosphere check valve 112 in the present embodiment differs from the atmosphere check valve 112 in the fourth embodiment in the structure that the casing 121 is formed integral with the casing 41 of the high-pressure regulator 30. Other structure is similar to that shown in FIGS. 7 and 8. The pipe 113 connected to this atmosphere check valve 112 is communicated to atmosphere through the hydrogen discharge passage 4 as in the fourth embodiment.

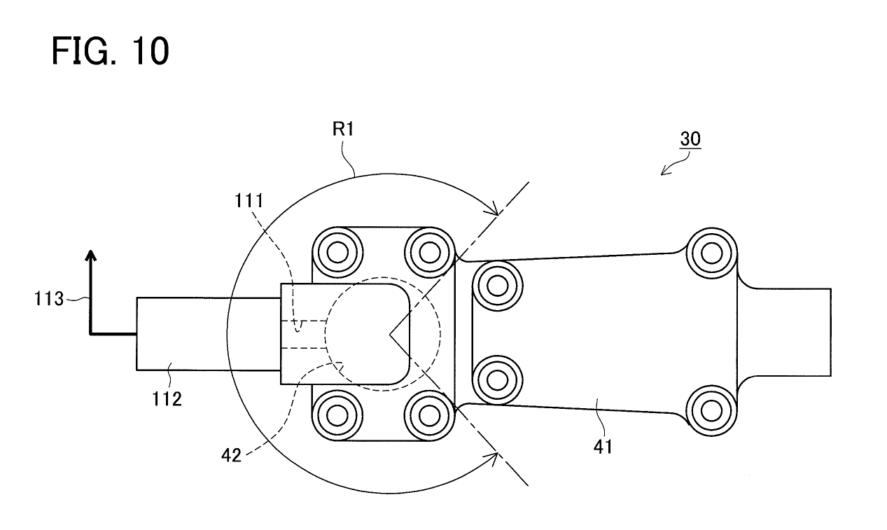

Therefore, the hydrogen supply system and the high-pressure regulator 30 in the present embodiment can also provide the equivalent operation advantage to that in the fourth embodiment. FIG. 10 is a plan view of this high-pressure regulator 30. The placement of the atmosphere communication passage 111 and the atmosphere check valve 112 in the high-pressure regulator 30 can provide the operation advantage equivalent to the placement in this embodiment only when the atmosphere communication passage 111 and the atmosphere check valve 112 are placed extending in a radial direction of the first cylinder 42 in a specified range R1 centered on the first cylinder 42 as indicated by an arrow in FIG. 10. In other words, even when the atmosphere communication passage 111 and the atmosphere check valve 112 are placed in this specified range R1 according to design need, the equivalent operation advantage to that in the present embodiment can be obtained.

Herein, the following gives a comparison between the placement of the atmosphere communication passage 111 and the atmosphere check valve 112 in the high-pressure regulator 30 in the present embodiment and the placement of the atmosphere communication passage 111 and the atmosphere check valve 112 in the high-pressure regulator 29 in the fourth embodiment. The pressure in the atmosphere communication passage 111 rises faster in a position closer to the opening 42a of the first cylinder 42, prompting the timing of starting the valve opening of the atmosphere check valve 112 by just that much, thus enabling suppressing the pressure rise in the middle passage 3b. Accordingly, the high-pressure regulator 30 can further improve the effect of suppressing the pressure rise due to the atmosphere check valve 112 than the high-pressure regulator 29. Since the high-pressure regulator 30 is not provided with the atmosphere communication passage 111 in the middle passage 3b, the inner diameter of the middle passage 3b can be set large regardless of the structure of atmosphere communication passage 111 and atmosphere check valve 112. Therefore, the inner diameter of the valve hole 121b of the valve seat 121a of the atmosphere check valve 112 in the high-pressure regulator 30 can be set larger than that in the high-pressure regulator 29, and thus the valve-opening responsivity of the atmosphere check valve 112 can be enhanced. Herein, even the high-pressure regulator 29 allows increasing of the inner diameter of the valve hole 121b. However, if the inner diameter of the middle passage 3b is relatively decreased, the middle passage 3b will function as a throttle, resulting in deteriorated valve-opening responsivity of the atmosphere check valve 112. The high-pressure regulator 30 in the present embodiment can avoid such a defect.

In the present embodiment, the atmosphere communication passage 111 and the atmosphere check valve 112 are placed adjacent to the opening 42a of the first cylinder 42 corresponding to the first regulator 8 placed on the upstream side and in a range not corresponding to a downstream side of the cylinder 42. Accordingly, the atmosphere communication passage 111 and the atmosphere check valve 112 are positioned close to the upstream end of the middle passage 3b, so that the pressure change of hydrogen gas acts on the atmosphere check valve 112 more rapidly by just that much. Thus, the unitized high-pressure regulator 30 including the first regulator 8 and the second regulator 9 can provide improved responsivity of the atmosphere check valve 112 to the pressure rise of hydrogen gas.

### Sixth Embodiment

A sixth embodiment of a fuel supply system and a pressure reducing device of the present invention embodied in a fuel cell system will be explained in detail, referring to the accompanying drawings.

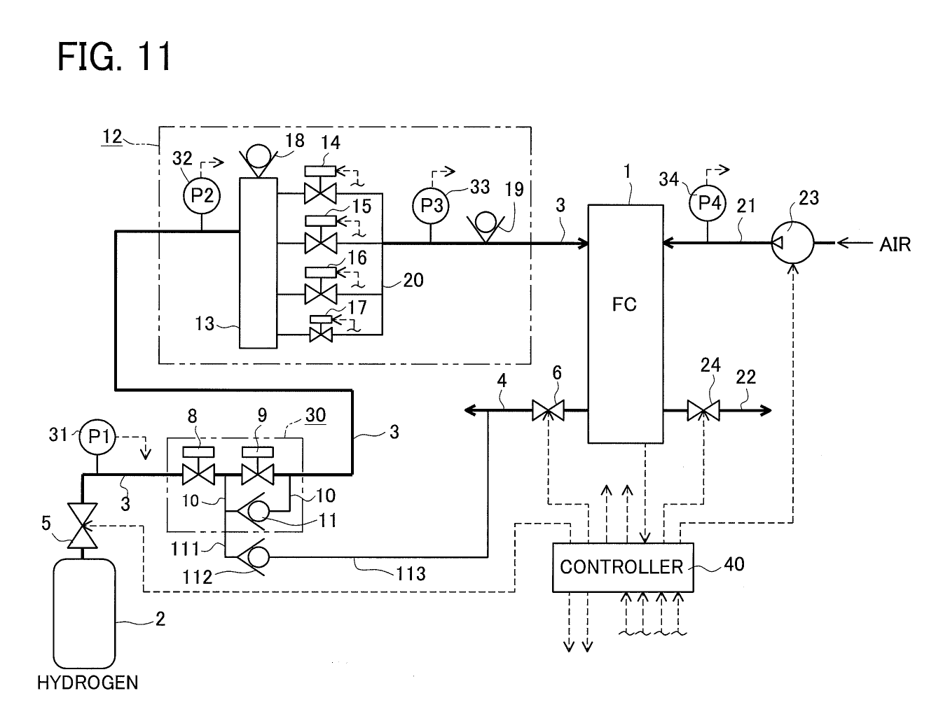

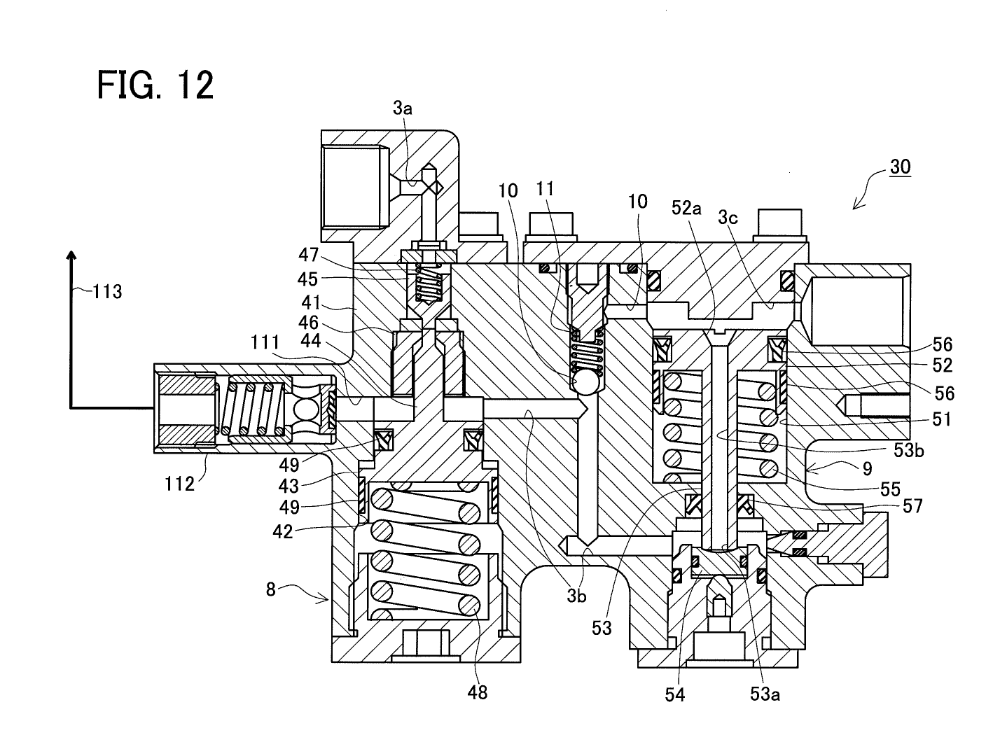

The sixth embodiment differs from the high-pressure regulator 30 of the fifth embodiment in that the communication passage 10 and the internal air check valve 11 are additionally provided. FIG. 11 is a schematic structural diagram of the fuel cell system in the present embodiment. FIG. 12 is a schematic sectional view of the high-pressure regulator 30. In the present embodiment, the high-pressure regulator 30 is provided with, in addition to the atmosphere communication passage 111 and the atmosphere check valve 112, the communication passage 10 allowing communication between the middle passage 3b and the rear passage 3c, and the internal air check valve 11 provided in the communication passage 10.

Specifically, the high-pressure regulator 30 in the present embodiment is provided with the atmosphere communication passage 111 and the atmosphere check valve 112 as in the fifth embodiment as shown in FIG. 12 and also provided with the communication passage 10 at some midpoint of the middle passage 3b, between the first regulator 8 and the second regulator 9, and the internal air check valve 11 is provided in the communication passage 10. In the present embodiment, the valve-opening pressure of the atmosphere check valve 112 is set larger than the valve-opening pressure of the internal air check valve 11. In the present embodiment, furthermore, a flow rate of the hydrogen gas in the atmosphere check valve 112 is set larger than a flow rate of the hydrogen gas in the internal air check valve 11.

Therefore, even the hydrogen supply system and high-pressure regulator 30 in the present embodiment can provide the equivalent operation advantage to that in the fifth embodiment. In the present embodiment, additionally, the communication passage 10 communicated with the rear passage 3c is provided at some midpoint of the middle passage 3b, and the internal air check valve 11 is provided in this communication passage 10. Further, the atmosphere check valve 112 provided in the atmosphere communication passage 111 is set larger in valve-opening pressure and a flow rate of fuel gas than the internal air check valve 11 provided in the communication passage 10. Accordingly, when the hydrogen gas slightly leaks out of the first regulator 8 into the middle passage 3b and the pressure of hydrogen gas in the middle passage 3b increases a little, the internal air check valve 11 with a relatively small valve-opening pressure and a low flow rate of hydrogen gas is opened to allow the hydrogen gas to flow from the middle passage 3b toward the rear passage 3c through the communication passage 10, so that the hydrogen gas in the middle passage 3b is pressure-reduced. This makes it possible to prevent the pressure of the hydrogen gas having leaked into the middle passage 3b from excessively increasing and thus prevent sealing failure and breakage of the seal members 49 and 57 facing the middle passage 3b. On the other hand, when the first regulator 8 remaining open is broken, a large amount of hydrogen gas is made to flow from the first regulator 8 into the middle passage 3b, causing a rapid increase in pressure of hydrogen gas in the middle passage 3b. In this case, the internal air check valve 11 is opened and also the atmosphere check valve 112 with a relatively large valve-opening pressure and a high flow rate of hydrogen gas is also opened, allowing the hydrogen gas to flow from the middle passage 3b to atmosphere through the atmosphere communication passage 111 and the pipe 113. Thus, the hydrogen gas in the middle passage 3b is rapidly pressure-reduced. This can prevent the pressure of hydrogen gas having flowed to the middle passage 3b from excessively increasing and thus prevent sealing failure and breakage of the seal members 49 and 57 facing the middle passage 3b. Further, the pressure resistance of the high-pressure regulator 30 can be ensured.

In the present embodiment, even when the pressure of hydrogen gas in the middle passage 3b between the first regulator 8 and the second regulator 9 increases, the atmosphere check valve 112 is opened to allow a flow of hydrogen gas from the middle passage 3b to atmosphere through the atmosphere communication passage 111 and/or the internal air check valve 11 is opened to allow a flow of hydrogen gas from the middle passage 3b toward the rear passage 3c through the communication passage 10, so that the hydrogen gas in the middle passage 3b is pressure-reduced. Accordingly, the atmosphere check valve 112 and the internal air check valve 11 can be either selectively activated or both simultaneously activated.

In the present embodiment, the valve-opening pressure of the atmosphere check valve 112 is set larger than the valve-opening pressure of the internal air check valve 11. In a stage where the pressure of the hydrogen gas in the middle passage 3b less increases, the internal air check valve 11 is first opened to allow the hydrogen gas to flow from the middle passage 3b toward the rear passage 3c through the communication passage 10, thereby reducing the pressure of the hydrogen gas in the middle passage 3b. When the pressure of the hydrogen gas in the middle passage 3b more increases, the atmosphere check valve 112 is opened to allow the hydrogen gas to flow from the middle passage 3b to atmosphere through the atmosphere communication passage 111, thereby reducing the pressure of the fuel gas in the middle passage 3b. Accordingly, the internal air check valve 11 and the atmosphere check valve 112 can be activated in stages according to the degree of increase in pressure of the hydrogen gas in the middle passage 3b. This can reduce wasteful consumption of hydrogen gas and ensure pressure resistance of the high-pressure regulator 30.

In the present embodiment, the flow rate of hydrogen gas in the atmosphere check valve 112 is set larger than the flow rate of hydrogen gas in the internal air check valve 11. Thus, in a stage where the pressure of hydrogen gas less increases, the internal air check valve 11 is opened to allow a small amount of hydrogen gas to adequately flow from the middle passage 3b toward the rear passage 3c through the communication passage 10, thereby reducing the pressure of the hydrogen gas in the middle passage 3b. When the pressure of the hydrogen gas in the middle passage 3b more increases, the atmosphere check valve 112 is opened to allow a large amount of hydrogen gas to flow from the middle passage 3b to atmosphere through the atmosphere communication passage 111 at once, thereby reducing the pressure of the hydrogen gas in the middle passage 3b. Accordingly, the internal air check valve 11 and the atmosphere check valve 112 can be activated in stages according to the degree of increase in pressure of the hydrogen gas in the middle passage 3b, thereby reducing wasteful consumption of hydrogen gas and ensuring pressure resistance of the high-pressure regulator 30.

### Seventh Embodiment

A seventh embodiment of a fuel supply system and a pressure reducing device of the present invention embodied in a fuel cell system will be explained in detail, referring to the accompanying drawings.

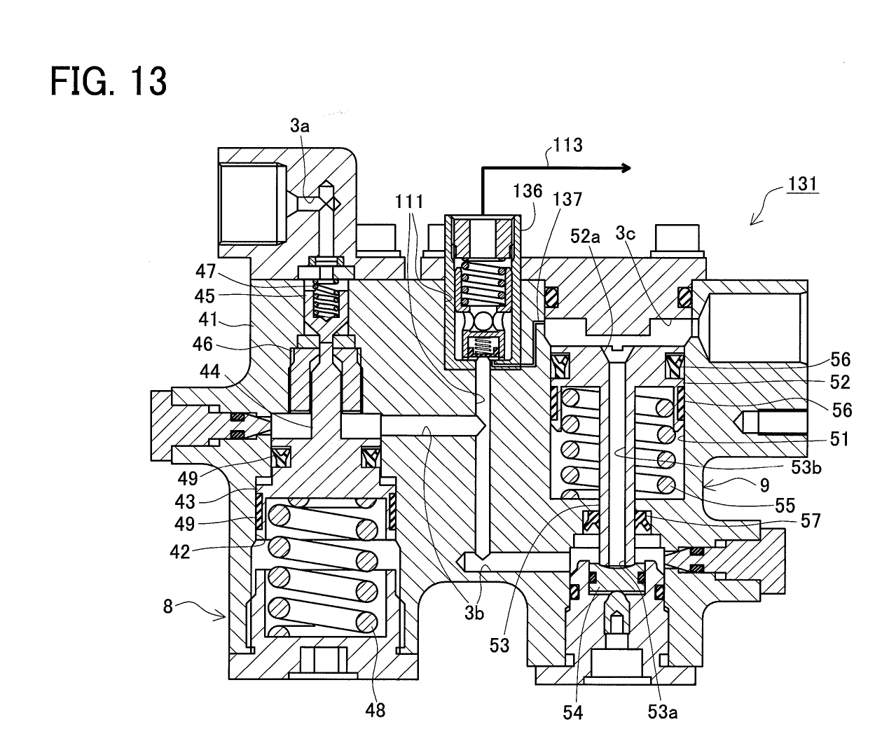

In the aforementioned sixth embodiment, the atmosphere check valve 112 provided in the atmosphere communication passage 111 and the internal air check valve 11 provided in the communication passage 10 are placed in separate positions in the casing 41. In contrast, the seventh embodiment differs from the sixth embodiment in the structure that a single check valve having both functions of the atmosphere check valve 112 and the internal air check valve 11 is provided in the casing 41. FIG. 13 is a schematic sectional view of a high-pressure regulator 131 in the seventh embodiment. The high-pressure regulator 131 in this embodiment has basically the same configuration as the high-pressure regulator 29 in the fourth embodiment excepting a two-stage check valve 136 and its surrounding structure. Specifically, as shown in FIG. 13, the two-stage check valve 136 of this embodiment is provided in the atmosphere communication passage 111 provided in the casing 41 between the first regulator 8 and the second regulator 9. Further, the casing 41 is formed with a communication passage 137, adjacent to the two-stage check valve 136, to allow communication between the atmosphere communication passage 111 communicating with the middle passage 3b and the rear passage 3c. The inner diameter of the communication passage 137 is set considerably smaller than the inner diameter of the atmosphere communication passage 111.

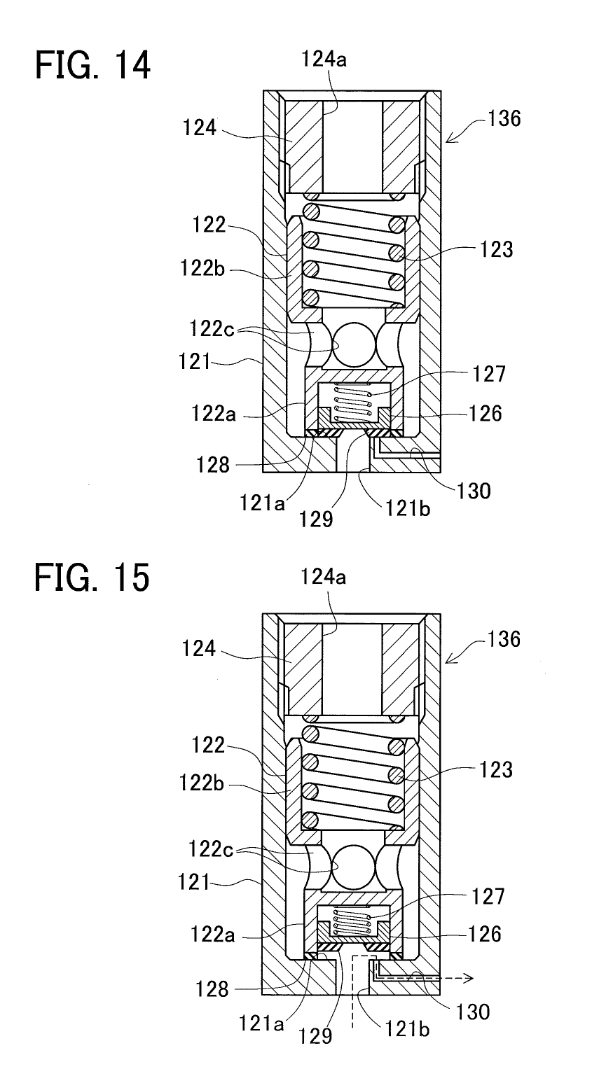

FIGS. 14, 15, and 16 are sectional views of the two-stage check valve 136. This two-stage check valve 136 has the equivalent configuration to the atmosphere check valve 112 provided in the atmosphere communication passage 111 as shown in FIGS. 7 and 8 in the fourth embodiment. Thus, the equivalent configuration to the atmosphere check valve 112 is assigned the same reference signs and its explanation is omitted. The following explanation is given with a focus on differences. As shown FIGS. 14 to 16, a small-diameter portion 122a of the valve element 122 is formed to be longer in an axial direction than the small-diameter portion 122a shown in FIGS. 7 and 8. In an internal space of the small-diameter portion 122a, a small valve element 126 having a disc-like shape is placed to be movable in the axial direction of the small-diameter portion 122a. Between an inner bottom surface of the small valve element 126 and an inner bottom surface of the small-diameter portion 122a, a spring 127 urging the small valve element 126 toward a valve seat 121a (in a valve-closing direction) is provided. Further, a rubber seal 128 is provided on a leading end (a lower end in FIGS. 14 to 16) of the small-diameter portion 122a in the axial direction so that the small-diameter portion 122a will contact with the valve seat 121a through the rubber seal 128. Similarly, a rubber seal 129 is provided on a leading end (a lower end in FIGS. 14 to 16) of the small valve element 126 in the axial direction so that the small valve element 126 will contact with the valve seat 121a through the rubber seal 129. Further, the casing 121 is formed with a communication hole 130 corresponding to the valve seat 121a. Specifically, one end of the communication hole 130 opens in a part of the surface of the valve seat 121a, with which the rubber seal 129 of the small valve element 126 will contact. The other end of the communication hole 130 is communicated with the communication passage 137 formed in the casing 41. The communication hole 130 constitutes a part of the communication passage 137, and the inner diameter of the communication hole 130 is set to be equal to that of the communication passage 137. Herein, the communication hole 130 is provided to make the communication passage 137 branch off from the atmosphere communication passage 111. Herein, the urging force of the spring 123 of the valve element 122 is set considerably larger than that of the spring 127 of the small valve element 126. Accordingly, the valve-opening pressure of the small valve element 126 in opening against the spring 127 from the valve-closed state contacting the valve seat 121a is set relatively small, while the valve-opening pressure of the small-diameter portion 122a of the valve element 122 in opening against the spring 123 from the valve-closed state together with the small valve element 126 is set relatively large.

As explained above, the valve element 122 (the small-diameter portion 122a) functions as an atmosphere check valve provided corresponding to the valve seat 121a to open and close the atmosphere communication passage 111. On the other hand, the small valve element 126 functions as an internal air check valve provided corresponding to the valve seat 121a to open and close the communication passage 137. In the present embodiment, specifically, the communication passage 137 is provided to branch off from the atmosphere communication passage 111, and the internal air check valve is configured to be integral with the atmosphere check valve in the vicinity of a portion of the communication passage 137 branching off from the atmosphere communication passage 111.

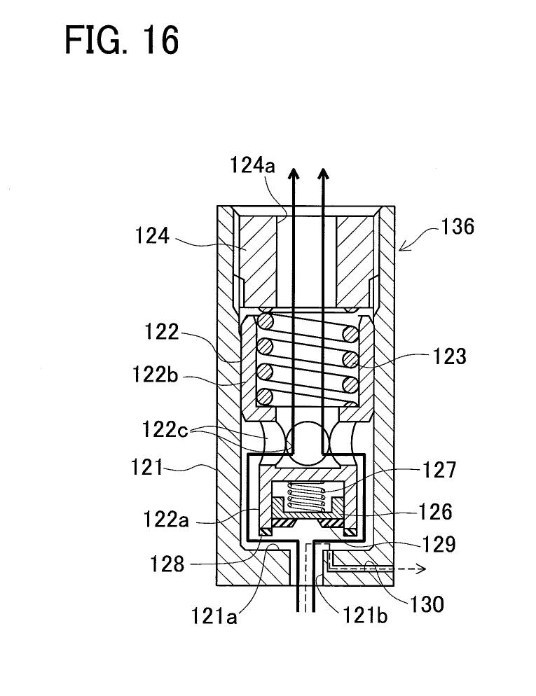

Accordingly, this two-stage check valve 136 opens in two stages according to a difference in pressure of hydrogen gas acting on the atmosphere communication passage 111 from the middle passage 3b in the high-pressure regulator 131. Specifically, when no hydrogen gas leaks into the middle passage 3b, the pressure of the hydrogen gas acting on the valve hole 121b of the valve seat 121a is extremely small. Thus, both the small-diameter portion 122a of the valve element 122 and the small valve element 126 contact with the valve seat 121a into a valve-closed state as shown in FIG. 14. On the other hand, when a slight amount of hydrogen gas leaks into the middle passage 3b, the pressure of the hydrogen gas acting on the valve hole 121b of the valve seat 121a increases. Thus, as shown in FIG. 15, only the small valve element 126 moves away from the valve seat 121a for valve opening, whereas the small-diameter portion 122a of the valve element 122 remains in the valve-closed state. Accordingly, the hydrogen gas slightly having leaked into the middle passage 3b flows from the valve hole 121b into the communication hole 130 as indicated by a broken arrow in FIG. 15, and then flows into the rear passage 3c through the communication passage 137. When a large amount of hydrogen gas leaks into the middle passage 3b, the pressure of the hydrogen gas acting on valve hole 121b of the casing 121 further increases. Thus, as shown in FIG. 16, the small-diameter portion 122a of the valve element 122 moves together with the small valve element 126 away from the valve seat 121a for valve opening. Accordingly, as indicated with thick arrows in FIG. 16, a large amount of the hydrogen gas having leaked into the middle passage 3b enters in the valve hole 121b, passes through a space between the valve seat 121a and the rubber seal 128, passes through the communication holes 122c and then the inside of the valve element 122, and flows out of the casing 121 through a hole 124a of a stopper 124 to escape to atmosphere through the pipe 13. Simultaneously, as indicated with a broken arrow in FIG. 16, part of the hydrogen gas flows from the valve hole 121b into the communication hole 130 to escape to the rear passage 3c through the communication passage 137. In this manner, the two-stage check valve 136 makes valve-opening in two stages.

As explained above, the hydrogen supply system and the high-pressure regulator 131 in the present embodiment can also provide the equivalent operation advantage to that in the sixth embodiment. In the present embodiment, additionally, the internal air check valve is integral with the atmosphere check valve to constitute the two-stage check valve 136 in the vicinity of a portion of the communication passage 137 branching off from the atmosphere communication passage 111. Accordingly, any additional space for the internal air check valve is not necessary. This can save the space for placing the internal air check valve and thus the high-pressure regulator 131 and hence the hydrogen supply system can be reduced in size by just that much.

### Eighth Embodiment

An eighth embodiment of a fuel supply system and a pressure reducing device of the present embodied in a bifuel engine system invention will be explained in detail, referring to the accompanying drawing.

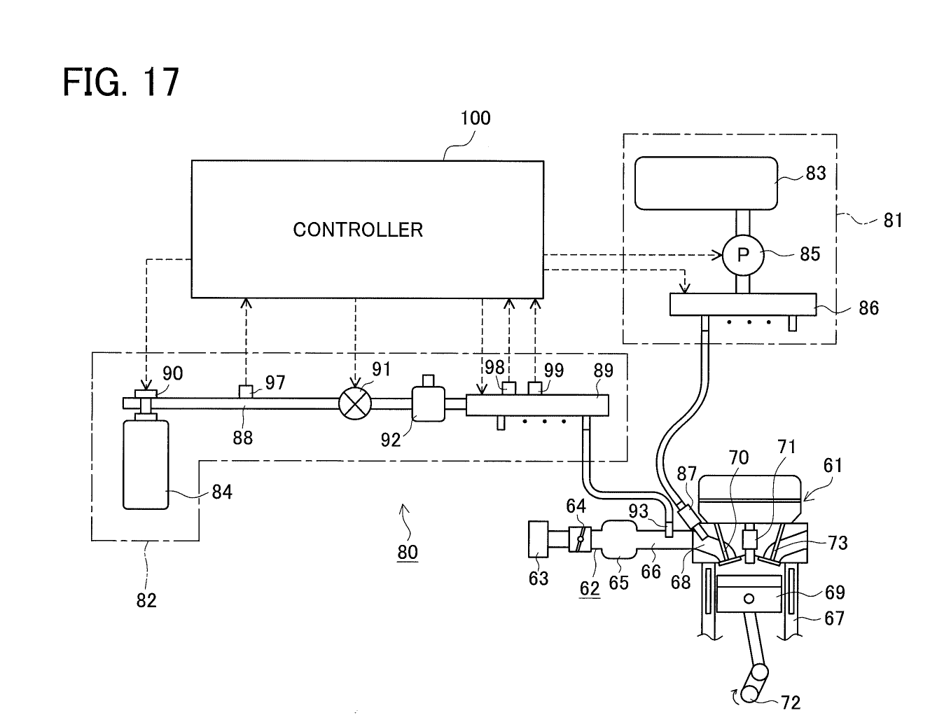

FIG. 17 is a schematic structural diagram of a bifuel engine system which will be mounted in a vehicle. The bifuel engine system includes an engine 61 which can run on gasoline and CNG (compressed natural gas) as fuel. In an intake passage 62 for introducing air sucked in through an inlet (not shown) to the engine 61, an air cleaner 63, a throttle valve 64, a surge tank 65, and others are arranged in the order from an upstream side of the passage 62. The air flowing in the surge tank 65 is distributed into a plurality of cylinders 67 provided in the engine 61 via an intake manifold 66. In the intake manifold 66 or intake ports 68, a mixture of fuel (CNG and gasoline) supplied from the fuel supply system 80 and air is generated. This air-fuel mixture is supplied into each cylinder 67.

Into one cylinder 67, the air-fuel mixture is supplied via an intake valve 70 at the timing when a piston 69 moves downward from a top dead point (Intake stroke). Then, in the relevant cylinder 67, the piston 69 is moved upward to compress the air-fuel mixture (Compression stroke). At the timing when the piston 69 having reached the top dead point starts to move downward again, the air-fuel mixture explodes and combusts in the cylinder 67 by ignition of an ignition plug 71, and the pressure deriving from the combustion is transmitted as power to a crank shaft 72 via the piston 69 (Combustion stroke). The crank shaft 72 is rotated by the transmitted power. Thereafter, when the piston 69 having reached a bottom dead point starts to move upward again, exhaust gas after the combustion is exhausted from the cylinder 67 via an exhaust valve 73 (Exhaust stroke).

The fuel supply system 80 includes a gasoline supply system 81 and a CNG supply system 82. The gasoline supply system 81 supplies gasoline stored in the gasoline tank 83 to each cylinder 67 of the engine 61 which is a supply destination. The CNG supply system 82 corresponds to one example of a fuel supply system of the invention and is operative to supply CNG (fuel gas) stored under high pressure in a CNG tank 84 to each cylinder 67 of the engine 61 which is a supply destination. The CNG tank 84 corresponds to one example of a fuel storage container of the invention.

The gasoline supply system 81 includes a fuel pump 85 operative to suck gasoline from the gasoline tank 83 and a gasoline delivery pipe 86 to which the fuel discharged from the fuel pump 85 will be introduced. This gasoline delivery pipe 86 is provided with a plurality of gasoline injectors 87 for injecting gasoline into corresponding internal parts of the intake manifold 66, one for each of the cylinders 67. These gasoline injectors 87 are individually controlled by a controller 100 on respective timings of injecting gasoline into the corresponding internal parts of the intake manifold 66.

The CNG supply system 82 includes a high-pressure fuel supply passage 88 connected to the CNG tank 84 and a delivery pipe 89 for CNG connected to a downstream end (a right end in FIG. 17) of the passage 88. Between the CNG tank 84 and the high-pressure fuel supply passage 88, there is provided a main valve 90 provided with a normally closed type electromagnetic valve whose opening and closing are controlled by the controller 100. While this main valve 90 is in a valve-closed state, the inside of the CNG tank 84 is in a hermetically sealed state.

In the high-pressure fuel supply passage 88, downstream of the main valve 90 (on a right side in FIG. 17), there are provided a first pressure sensor 97 for detecting the pressure in the high-pressure fuel supply passage 88 and a cutoff valve 91 controlled by the controller 100 to open and close. When the main valve 90 and the cutoff valve 91 are in a valve-open state, CNG in the CNG tank 84 is supplied to the CNG delivery pipe 89 through the high-pressure fuel supply passage 88. On the other hand, when the cutoff valve 91 is brought into a valve-closed state, the CNG is not supplied to the CNG delivery pipe 89.

On a downstream side of the cutoff valve 91 in the high-pressure fuel supply passage 88, a high-pressure regulator 92 is provided to reduce the pressure of CNG to be supplied from the CNG tank 84, that is, the pressure of fuel gas (fuel pressure). This high-pressure regulator 92 corresponds to one example of a pressure reducing device of the invention and is operative to supply CNG of a predetermined fuel pressure to the CNG delivery pipe 89. Herein, as this regulator 92, for example, the high-pressure regulators 7, 27-30, and 131 explained respectively in the above embodiments may be used.

In the CNG delivery pipe 89, a plurality of CNG injectors 93 are provided to inject CNG into corresponding internal parts of the intake manifold 66, one for each of the cylinders 67. Further, in the CNG delivery pipe 89, there are provided a second pressure sensor 98 for detecting the pressure in the pipe 89 and a temperature sensor 99 for detecting the temperature of CNG supplied into the CNG delivery pipe 89. The CNG injectors 93 are individually controlled on respective timings of injecting CNG into the corresponding internal parts of the intake manifold 66 and others by the controller 100 that receives detection signals from the second pressure sensor 98 and the temperature sensor 99. In the present embodiment, each of the CNG injectors 93 corresponds to one example of a fuel flow regulating device of the invention.

Accordingly, in the bifuel engine system in the present embodiment, in the high-pressure fuel supply passage 88 for supplying CNG to the engine 61, the regulator 92 can exhibit the equivalent operation advantage to that in each of the aforementioned embodiments. The present invention is not limited to each of the aforementioned embodiments and may be embodied in other specific forms without departing from the essential characteristics thereof.

In the above-mentioned embodiments, the pressure reducing device of the present invention is embodied into the high-pressure regulator 7, 27-30, or 131, including two high-pressure regulators, i.e., the first regulator 8 and the second regulator 9. As an alternative, the pressure reducing device may be embodied into a high-pressure regulator (pressure reducing device) provided with three or more high-pressure regulators (pressure reducing valves).

In the eighth embodiment, the fuel supply system of the present invention is embodied into the bifuel engine system which runs on gasoline and CNG (compressed natural gas), but may be embodied into a monofuel engine system which runs on CNG (compressed natural gas) alone.

### INDUSTRIAL APPLICABILITY

The present invention is utilizable as a constituent element of an internal combustion engine or a fuel cell to be mounted in a vehicle.

### REFERENCE SIGNS LIST

1 Fuel cell (Supply destination)
2 Hydrogen cylinder (Fuel storage container)
3 Hydrogen supply passage (Fuel supply passage)
3a Front passage
3b Middle passage
3c Rear passage
7 High-pressure regulator (Pressure reducing device)
8 First regulator (First pressure reducing valve)
9 Second regulator (Second pressure reducing valve)
10 Communication passage
11 Internal air check valve
12 Hydrogen flow regulating device (Fuel flow regulating device)
27 High-pressure regulator (Pressure reducing device)
28 High-pressure regulator (Pressure reducing device)
29 High-pressure regulator (Pressure reducing device)
30 High-pressure regulator (Pressure reducing device)
42 First cylinder
42a Opening
43 First piston
61 Engine (Supply destination)
82 CNG supply system
84 CNG tank (Fuel storage container)
88 High-pressure fuel supply passage (Fuel supply passage)
89 CNG delivery pipe (Fuel supply passage)
92 High-pressure regulator (Pressure reducing device)
93 CNG injector (Fuel flow regulating device)
111 Atmosphere communication passage
112 Atmosphere check valve
113 Pipe (Atmosphere communication passage)
130 Communication hole (Communication passage)
131 High-pressure regulator (Pressure reducing device)
136 Two-stage check valve
137 Communication passage

1. A fuel supply system including:
a fuel storage container for storing fuel gas;
a fuel supply passage for supplying the fuel gas from the fuel storage container to a supply destination;
a plurality of pressure reducing valves provided in the fuel supply passage downstream of the fuel storage container and arranged in series to reduce pressure of the fuel gas; and
a fuel flow regulating device provided in the fuel supply passage downstream of the plurality of pressure reducing valves and configured to regulate a flow rate of fuel gas to be supplied to the supply destination,
wherein the plurality of pressure reducing valves include a first pressure reducing valve placed on an uppermost side and a second pressure reducing valve placed next to the first pressure reducing valve, and
the fuel supply system includes:
a middle passage in which fuel gas after being pressure-reduced by the first pressure reducing valve and before being pressure-reduced by the second pressure reducing valve;
a rear passage in which the fuel gas after being pressure-reduced by the second pressure reducing valve; and
a gas releasing device configured to release the fuel gas from the middle passage only when pressure of the fuel gas in the middle passage becomes excessive.

2. The fuel supply system according to claim 1, wherein
the gas releasing device includes:
a communication passage allowing communication between the middle passage and the rear passage; and
an internal air check valve provided in the communication passage and configured to allow a flow of fuel gas in a direction from the middle passage toward the rear passage and block a flow of fuel gas in a reverse direction from the rear passage toward the middle passage.

3. The fuel supply system according to claim 2, wherein
the first pressure reducing valve, the second pressure reducing valve, the middle passage, the rear passage, the communication passage, and the internal air check valve are integrally constituted as a single unit, and
the unit is configured such that the first pressure reducing valve is placed on an upstream side, the second pressure reducing valve is placed on a downstream side, and the communication passage and the internal air check valve are placed between the first pressure reducing valve and the second pressure reducing valve.

4. A pressure reducing device which will be used in the fuel supply system according to claim 2, wherein the first pressure reducing valve, the second pressure reducing valve, the middle passage, the rear passage, the communication passage, and the internal air check valve are integrally constituted so that the first pressure reducing valve is placed on an upstream side, the second pressure reducing valve is placed on a downstream side, and the communication passage and the internal air check valve are placed between the first pressure reducing valve and the second pressure reducing valve.

5. The fuel supply system according to claim 1,
wherein the gas releasing device includes:
an atmosphere communication passage allowing communication between the middle passage and atmosphere; and
an atmosphere check valve provided in the atmosphere communication passage and configured to allow a flow of fuel gas in a direction from the middle passage toward the atmosphere communication passage and block a flow of the fuel gas in a reverse direction from the atmosphere communication passage toward the middle passage.

6. The fuel supply system according to claim 5, wherein
the first pressure reducing valve, the second pressure reducing valve, the middle passage, the rear passage, the atmosphere communication passage, and the atmosphere check valve are integrally constituted as a single unit,
the unit is configured such that the first pressure reducing valve is placed on an upstream side, the second pressure reducing valve is placed on a downstream side, and the atmosphere communication passage and the atmosphere check valve are placed between the first pressure reducing valve and the second pressure reducing valve.

7. The fuel supply system according to claim 5, wherein
the first pressure reducing valve, the second pressure reducing valve, the middle passage, the rear passage, the atmosphere communication passage, and the atmosphere check valve are integrally constituted as a single unit, and
the first pressure reducing valve includes a cylinder and a piston, and the cylinder has an opening communicated with the middle passage, and
the unit is configured such that the first pressure reducing valve is placed on an upstream side, the second pressure reducing valve is placed on a downstream side, and the atmosphere communication passage and the atmosphere check valve are placed adjacent to the opening of the cylinder corresponding to the first pressure reducing valve and in a range not corresponding to a downstream side of the cylinder.

8. The fuel supply system according to claim 5, further including:
a communication passage allowing communication between the middle passage and the rear passage; and
an internal air check valve provided in the communication passage and configured to allow a flow of fuel gas in a direction from the middle passage toward the rear passage and block a flow of the fuel gas in a reverse direction from the rear passage toward the middle passage.

9. The fuel supply system according to claim 8, wherein a valve-opening pressure of the atmosphere check valve is set to be larger than a valve-opening pressure of the internal air check valve.

10. The fuel supply system according to claim 8, wherein a flow rate of the fuel gas in the atmosphere check valve is set to be larger than a flow rate of the fuel gas in the internal air check valve.

11. The fuel supply system according to claim 8, wherein the communication passage is provided to branch off from the atmosphere communication passage, and the internal air check valve is constituted integral with the atmosphere check valve in a vicinity of a portion of the communication passage branching off from the atmosphere communication passage.

12. The fuel supply system according claim 9, wherein the communication passage is provided to branch off from the atmosphere communication passage, and the internal air check valve is constituted integral with the atmosphere check valve in a vicinity of a portion of the communication passage branching off from the atmosphere communication passage.

13. The fuel supply system according claim 10, wherein the communication passage is provided to branch off from the atmosphere communication passage, and the internal air check valve is constituted integral with the atmosphere check valve in a vicinity of a portion of the communication passage branching off from the atmosphere communication passage.

14. A pressure reducing device which will be used in the fuel supply system according to claim 5, wherein
the first pressure reducing valve, the second pressure reducing valve, the middle passage, the rear passage, the atmosphere communication passage, and the atmosphere check valve are integrally constituted as a single unit, and
the unit is configured such that the first pressure reducing valve is placed on an upstream side, the second pressure reducing valve is placed on a downstream side, and the atmosphere communication passage and the atmosphere check valve are placed between the first pressure reducing valve and the second pressure reducing valve.

15. A pressure reducing device which will be used in the fuel supply system according to claim 7, wherein
the first pressure reducing valve, the second pressure reducing valve, the middle passage, the rear passage, the atmosphere communication passage, and the atmosphere check valve are integrally constituted as a single unit, and
the atmosphere communication passage and the atmosphere check valve are placed adjacent to the opening of the cylinder corresponding to the first pressure reducing valve and in a range not corresponding to a downstream side of the cylinder.
